(19) United States
(12) Patent Application Publication
(10) Pub. No.: US 2026/0358659 A1
(43) Pub. Date: Nov. 12, 2026

(54) DISPLAY DEVICE

(71) Applicant: Sharp Display Technology Corporation, Kameyama City (JP)

(72) Inventors: Masahiro DATE, Kameyama City (JP); Hiroto AKIYAMA, Kameyama City (JP)

(21) Appl. No.: 19/665,438

(22) Filed: May 1, 2026

(30) Foreign Application Priority Data
May 12, 2025 (JP) 2025-079890

(51) Int. Cl. G02F 1/1333; G02F 1/1337; G02F 1/1339; G02F 1/1343; G02F 1/1362; G02F 1/1368

(52) U.S. Cl. CPC G02F 1/133368; G02F 1/1337; G02F 1/13394; G02F 1/13396; G02F 1/134372; G02F 1/136227; G02F 1/1368

(57) ABSTRACT

A display device includes a first substrate, a second substrate facing the first substrate with a gap between the first substrate and the second substrate, a first spacer provided in the first substrate and protruding from the first substrate toward the second substrate, an alignment film provided in the second substrate and located in an uppermost layer, and a first insulating film provided in the second substrate and disposed on a lower layer side from the alignment film. The first insulating film includes a first portion having a first upper surface as an upper surface and a second portion having a second upper surface higher than the first upper surface as an upper surface. The second portion overlaps the first spacer. The first portion includes a groove portion surrounding the second portion.

### CROSS-REFERENCE TO RELATED APPLICATIONS

This application claims the benefit of priority to Japanese Patent Application Number 2025-079890 filed on May 12, 2025. The entire contents of the above-identified application are hereby incorporated by reference.

### BACKGROUND

### Technical Field

The technique disclosed in the present specification relates to a display device by which a deterioration in display quality is suppressed.

In the related art, a liquid crystal display device described in JP 2001-133791 A is known as an example of a display device. The liquid crystal display device described in JP 2001-133791 A includes an array substrate in which a wiring line portion is formed on one main surface, a counter substrate arranged to face the array substrate, a columnar spacer forming a predetermined gap between the array substrate and the counter substrate, and a liquid crystal layer arranged in the predetermined gap formed by the columnar spacer. In the liquid crystal display device, the columnar spacer has a constriction on a side surface thereof, and a maximum diameter portion above the constriction in a height direction is positioned below a tip end position.

### SUMMARY

According to the liquid crystal display device described in JP 2001-133791 A, it is possible to achieve both an improvement in the aperture ratio and to maintain a gap, while suppressing scraping of the columnar spacer due to a rubbing treatment. However, an alignment film located in an uppermost layer in the array substrate covers the columnar spacer. Therefore, when friction occurs in a state in which the columnar spacer contacts the counter substrate, a portion of the alignment film covering a tip end surface of the columnar spacer may be scraped off and form suspended foreign matter floating in the liquid crystal. If suspended foreign matter is present in the liquid crystal, the foreign matter may cause a bright spot defect, and may deteriorate the display quality.

The techniques described herein have been contrived with regard to the circumstances described above, and an object thereof is to suppress a deterioration of the display quality.

(1) A display device according to a technique described herein includes a first substrate, a second substrate facing the first substrate with a gap between the first substrate and the second substrate, a first spacer provided in the first substrate and protruding from the first substrate toward the second substrate, an alignment film provided in the second substrate and located in an uppermost layer, and a first insulating film provided in the second substrate and disposed on a lower layer side from the alignment film, the first insulating film includes a first portion having a first upper surface as an upper surface and a second portion having a second upper surface higher than the first upper surface as an upper surface, the second portion overlaps the first spacer, and the first portion includes a groove portion surrounding the second portion.

(2) In the display device, in addition to (1) described above, the groove portion may have an annular shape surrounding the entire periphery of the second portion.

(3) In the display device, in addition to (1) or (2) described above, the groove portion may extend along a planar shape of the second portion.

(4) In the display device, in addition to any one of (1) to (3) described above, the groove portion may have a recessed shape including a bottom surface.

(5) In the display device, in addition to any one of (1) to (3) described above, the groove portion may extend through the first portion.

(6) The display device may include, in addition to (5) described above, a thin film transistor provided in the second substrate, and a pixel electrode provided in the second substrate and connected to the thin film transistor, the thin film transistor may include a first electrode disposed on a lower layer side of the first insulating film and overlapping a part of the pixel electrode and a part of the first portion, and a contact hole connecting the first electrode and the pixel electrode may extend through the first portion at a position overlapping both the first electrode and the pixel electrode.

(7) The display device may include, in addition to any one of (1) to (6) described above, a second spacer provided in the first substrate and protruding from the first substrate toward the second substrate, the second spacer may have a smaller protruding dimension from the first substrate than a protruding dimension of the first spacer, the first insulating film may include a third portion having, as an upper surface, a third upper surface that is higher than the first upper surface and that has the same height as the second upper surface or is lower than the second upper surface, the third portion may overlap the second spacer, and a portion overlapping the first spacer in a surface of the first substrate facing the second substrate, may contact a portion overlapping the second portion in a surface of the second substrate facing the first substrate.

According to the technique described herein, a deterioration of the display quality can be suppressed.

### BRIEF DESCRIPTION OF DRAWINGS

The disclosure will be described with reference to the accompanying drawings, wherein like numbers reference like elements.

FIG. 1 is a plan view of a liquid crystal panel, a flexible substrate, and a control substrate according to a first embodiment.

FIG. 2 is a cross-sectional view of the liquid crystal panel, the flexible substrate, and the control substrate according to the first embodiment.

FIG. 3 is a plan view illustrating a pixel arrangement in a display region of an array substrate provided in the liquid crystal panel according to the first embodiment.

FIG. 4 is a plan view illustrating a pixel arrangement of a counter substrate provided in the liquid crystal panel according to the first embodiment.

FIG. 5 is a cross-sectional view of the liquid crystal panel according to the first embodiment, taken along line v-v in FIG. 3.

FIG. 6 is a cross-sectional view of the liquid crystal panel according to the first embodiment, taken along line vi-vi in FIG. 3.

FIG. 7 is a cross-sectional view of the liquid crystal panel according to the first embodiment, taken along line vii-vii in FIG. 3.

FIG. 8 is an enlarged plan view of a second portion and the vicinity thereof in the array substrate according to the first embodiment.

FIG. 9 is an enlarged plan view of a third portion and the vicinity thereof in the array substrate according to the first embodiment.

FIG. 10 is a cross-sectional view illustrating a state in which a material of a second alignment film is supplied in a ninth step included in an array substrate manufacturing process according to the first embodiment, cut at the same position as FIG. 6.

FIG. 11 is a cross-sectional view of a liquid crystal panel according to a second embodiment, cut at the same position as FIG. 6.

FIG. 12 is an enlarged plan view of a second portion and the vicinity thereof in an array substrate according to a third embodiment.

### DESCRIPTION OF EMBODIMENTS

### First Embodiment

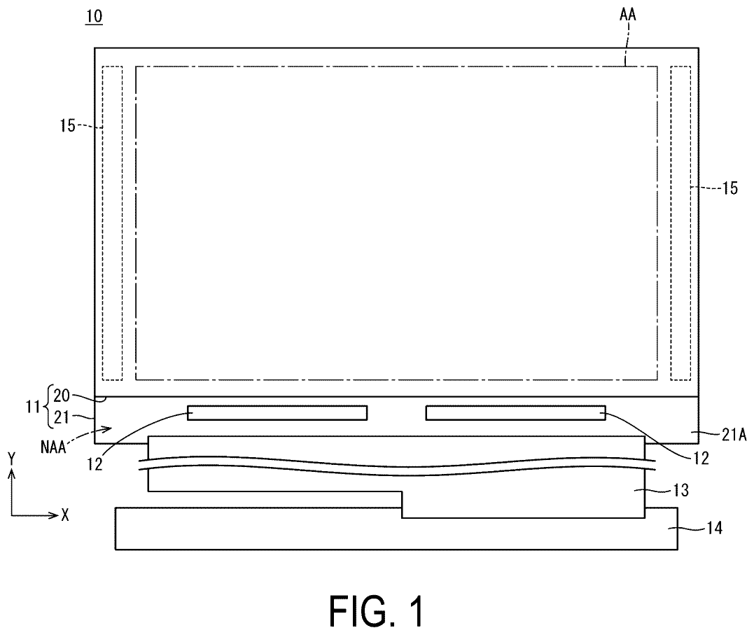

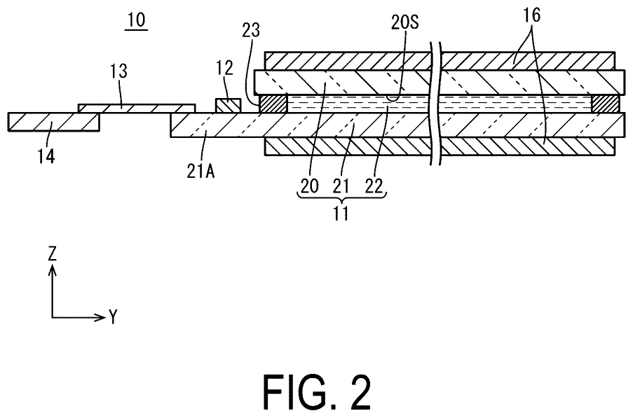

A first embodiment will be described with reference to FIGS. 1 to 10. In the present embodiment, a liquid crystal display device (a display device) 10 is described. Note that some drawings illustrate an X-axis, a Y-axis, and a Z-axis, and directions of these axes are drawn so as to be common in all the drawings. In FIGS. 2, 6, 7, and 10, an upper side is defined as a front side and a lower side is defined as a rear side.

The liquid crystal display device 10, as illustrated in FIG. 1, includes at least a liquid crystal panel (display panel) 11, which has a horizontally elongated rectangular shape and is capable of displaying an image, and a backlight device (illumination device) that emits light utilized to perform display on the liquid crystal panel 11. The backlight device is arranged on the rear side (back surface side) of the liquid crystal panel 11 and has a known configuration. In the liquid crystal panel 11, a central side portion of a main surface is a display region AA in which an image is displayed, and an outer peripheral side portion having a frame-like shape (frame shape) surrounding the display region AA is a non-display region NAA in which no image is displayed.

As illustrated in FIGS. 1 and 2, the liquid crystal panel 11 is formed by bonding a pair of substrates 20 and 21 together. Among the pair of substrates 20 and 21, the substrate on the front side is a counter substrate (first substrate) 20, and the substrate on the rear side is an array substrate (second substrate) 21. The counter substrate 20 and the array substrate 21 are each formed by layering various types of films on an inner surface side of a glass substrate (support substrate). A liquid crystal layer 22 is arranged to be interposed between the pair of substrates 20 and 21 and contains liquid crystal molecules, which are substances having optical characteristics that change when an electric field is applied. A sealing portion 23 that seals the liquid crystal layer 22 is provided to be interposed between outer peripheral end portions of the pair of substrates 20 and 21. The sealing portion 23 is formed in a rectangular frame-like shape so as to surround the liquid crystal layer 22. Note that polarizers 16 are bonded to outer surface sides of both the substrates 20 and 21.

As illustrated in FIGS. 1 and 2, a short side dimension of the counter substrate 20 is shorter than a short side dimension of the array substrate 21. The counter substrate 20 is bonded to the array substrate 21 with one end portion in a short side direction (Y-axis direction) aligned with the array substrate 21. Thus, the other end portion of the array substrate 21 in the short side direction is an exposed portion 21A that protrudes laterally with respect to the counter substrate 20 and is exposed. The entire region of the exposed portion 21A forms the non-display region NAA, and a driver (signal supply unit) 12 used for supplying various types of signals and a flexible substrate 13 are mounted thereon. The driver 12 is formed of an LSI chip including a drive circuit therein, and processes various types of signals to supply, for example, an image signal to a source wiring line 27 described later. The flexible substrate 13 transmits a signal from a control substrate 14 to the array substrate 21. The control substrate 14 includes a circuit component such as a power source integrated circuit (IC), a timing controller, and a level shifter IC, and supplies various types of signals to the flexible substrate 13.

As illustrated in FIG. 1, gate drive circuits 15 are provided in the non-display region NAA of the array substrate 21. The gate drive circuits 15 are provided as a pair so as to sandwich the display region AA from both sides in the X-axis direction. Each of the gate drive circuits 15 is provided in a range having a vertically elongated belt shape extending along the short side direction (Y-axis direction) of the array substrate 21. The gate drive circuit 15 is a circuit used for supplying a scanning signal to a gate wiring line 26 to be described later and is provided monolithically in the array substrate 21. The scanning signal includes a potential higher than a threshold voltage of a TFT 24 to be described later.

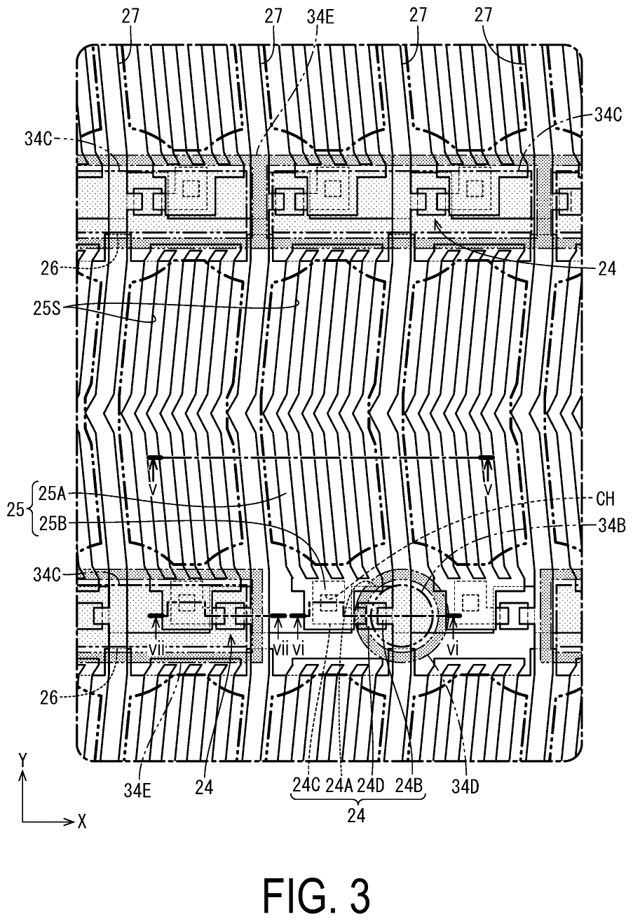

A pixel arrangement of the display region AA in the array substrate 21 will be described with reference to FIG. 3. As illustrated in FIG. 3, the thin film transistor (TFT, switching element) 24 and a pixel electrode 25 connected to the TFT 24 are each provided as a plurality aligned in a matrix shape in the display region AA of the array substrate 21. The gate wiring lines (scanning wiring lines) 26 and the source wiring lines (data wiring lines, signal wiring lines) 27, which are substantially formed in a lattice pattern, are disposed so as to surround the TFT 24 and the pixel electrode 25. Each of the gate wiring lines 26 extends substantially in the X-axis direction to cross the display region AA, and is connected to a gate electrode 24A of a corresponding one of the TFTs 24. The plurality of gate wiring lines 26 are disposed side by side at intervals in the Y-axis direction. Each of the source wiring lines 27 extends substantially in the Y-axis direction (a first direction) to cross the display region AA, and is connected to a source electrode 24B of a corresponding one of the TFTs 24. The plurality of source wiring lines 27 are disposed at intervals in the X-axis direction (a second direction intersecting the first direction). Each of the pixel electrodes 25 is connected to a drain electrode (first electrode) 24C of a corresponding one of the TFTs 24.

As illustrated in FIG. 3, in addition to the above-mentioned gate electrode 24A, the source electrode 24B, and the drain electrode 24C, the TFT 24 includes a semiconductor portion 24D. The semiconductor portion 24D is formed of a semiconductor material and connected to the source electrode 24B and the drain electrode 24C. When the TFT 24 is driven based on the scanning signal supplied to the gate wiring line 26, the TFT 24 charges the pixel electrode 25 to a potential based on an image signal (a data signal) supplied to the source wiring line 27. The TFTs 24 are arrayed in a zig-zag shape, so that TFTs 24 connected to the pixel electrodes 25 on one side (the left side in FIG. 3) in the X-axis direction and TFTs 24 connected to the pixel electrodes 25 on the other side (the right side in FIG. 3) in the X-axis direction, with respect to the source wiring line 27 to which a corresponding one of the TFTs 24 is to be connected, are aligned repeatedly and alternately in the Y-axis direction.

As illustrated in FIG. 3, each of the pixel electrodes 25 is disposed in a region having a vertically elongated, substantially rectangular shape surrounded by the gate wiring line 26 and the source wiring line 27. The pixel electrode 25 includes a main body portion 25A having a vertically elongated planar shape, and a contact portion 25B connected to the drain electrode 24C of a corresponding one of the TFTs 24. The main body portion 25A is bent midway in a direction of a long side (longitudinal direction) of the main body portion 25A. Specifically, both side edges of the main body portion 25A at longitudinal sides thereof are slightly inclined with respect to the Y-axis direction, and bent once at a substantially central position, thereby forming a shallow V-shape in which the apex angle is an obtuse angle. The main body portion 25A includes a bent portion at a substantially central position in the longitudinal direction. The pixel electrode 25 is sandwiched from both sides in the Y-axis direction (longitudinal direction) by a pair of the gate wiring lines 26, and is sandwiched from both sides in the X-axis direction (short-hand direction) by a pair of the source wiring lines 27. The source wiring line 27 interposed between pixel electrodes 25 adjacent to each other in the X-axis direction is parallel to the side edges at the longitudinal sides of the pixel electrodes 25, and is repeatedly bent in a zig-zag shape following the side edges at the longitudinal sides of the pixel electrodes 25. In the main body portion 25A, a plurality of slits 25S parallel to the source wiring line 27 are provided so as to be aligned at intervals in the X-axis direction. The contact portion 25B extends from the main body portion 25A along the Y-axis direction toward the gate wiring line 26 (the lower side in FIG. 3) connected to the TFT 24 including the drain electrode 24C to which the contact portion 25B is to be connected. The contact portion 25B has a substantially rectangular shape in a plan view.

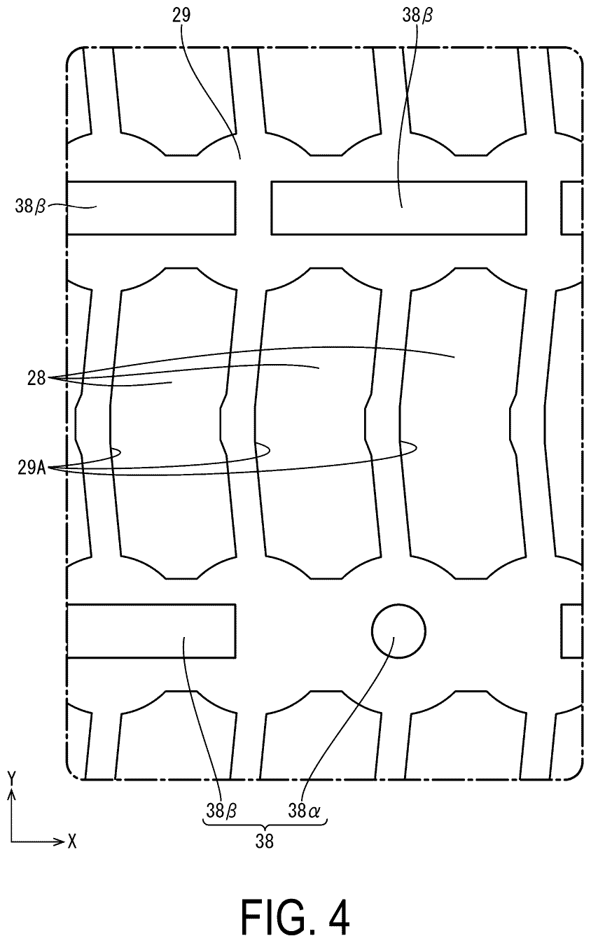

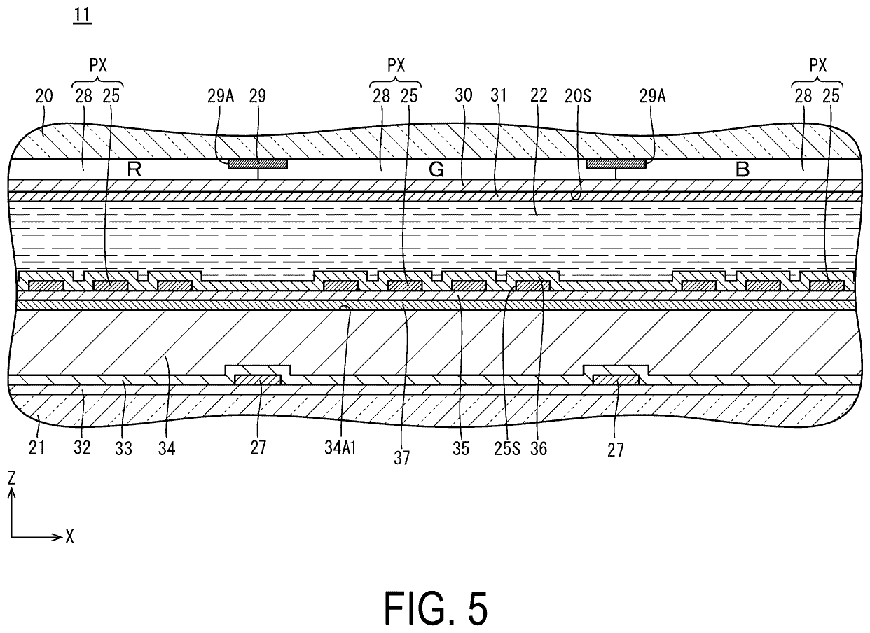

As illustrated in FIG. 4, in the display region AA of the counter substrate 20 constituting the liquid crystal panel 11, a large number of color filters 28 are provided at positions overlapping corresponding ones of the pixel electrodes 25 included in the array substrate 21. The color filters 28 are arrayed in a pattern in which three colors including red (R), green (G), and blue (B) are alternately and repeatedly aligned along the X-axis direction. The color filters 28 of the three colors extend along the Y-axis direction, and thus, are substantially arrayed in a stripe shape as a whole. Specifically, each of the three color filters 28 substantially extends along the Y-axis direction so as to be parallel to the side edges of the source wiring lines 27, and the color filters 28 are repeatedly bent in a zig-zag shape following the side edges of the source wiring lines 27. As illustrated in FIG. 5, the color filters 28 face the pixel electrodes 25 at the side of the array substrate 21. The color filter 28 and the pixel electrode 25 facing each other form a pixel PX serving as a display unit.

As illustrated in FIG. 4, in the display region AA of the counter substrate 20, a light blocking portion (black matrix) 29 is provided that partitions an area (boundary) between color filters 28 (pixel electrodes 25) adjacent to each other in the X-axis direction and the Y-axis direction. The light blocking portion 29 is provided not only in the display region AA, but also in the non-display region NAA. As illustrated in FIG. 5, the light blocking portion 29 overlaps the TFT 24, the gate wiring line 26, and the source wiring line 27 in the display region AA, and a planar shape of the light blocking portion 29 substantially forms a lattice pattern so as to partition the area between adjacent ones of the pixel electrodes 25. The light blocking portion 29 includes a pixel opening portion 29A at a position overlapping a large portion of the pixel electrode 25 in a plan view. Light transmitted through the pixel electrode 25 can be emitted to the outside of the liquid crystal panel 11 by the pixel opening portion 29A. The light blocking portion 29 is substantially solid in the non-display region NAA. An overcoat film 30 is formed on an upper layer side of each of the color filters 28 and the light blocking portion 29. The overcoat film 30 is solidly provided over substantially the entire region of the counter substrate 20. For example, the overcoat film 30 is formed of an organic material such as an acrylic resin (for example, PMMA). An inner surface of the counter substrate 20 (a surface facing the array substrate 21) is leveled by the overcoat film 30. An upper surface (front surface) of the overcoat film 30 constitutes a first main surface 20S serving as a reference plane in the counter substrate 20. Note that a first alignment film 31 used for aligning the liquid crystal molecules contained in the liquid crystal layer 22 is provided on the upper layer side of the overcoat film 30 (an innermost surface of the counter substrate 20). The first alignment film 31 is made of polyimide, for example.

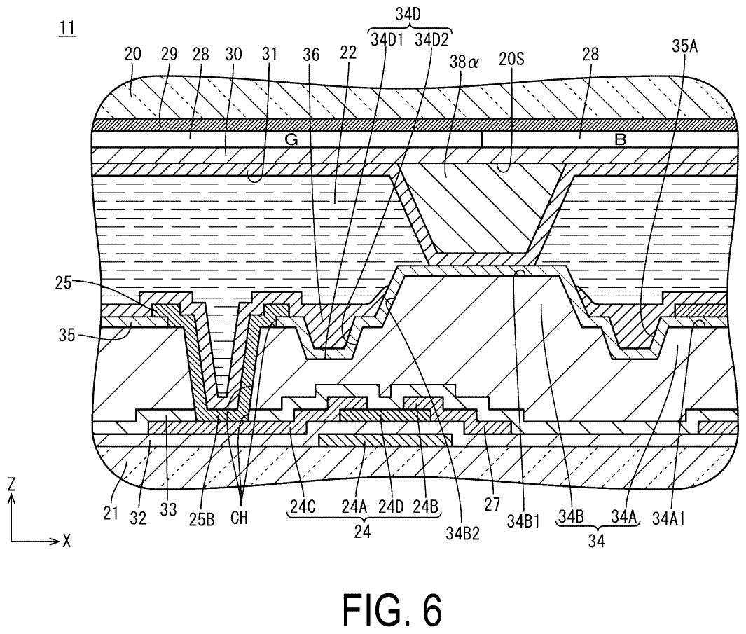

Here, various types of films formed as layers on an inner surface side of the array substrate 21 will be described with reference to FIGS. 5 and 6. As illustrated in FIGS. 5 and 6, a first metal layer, a gate insulating film 32, a semiconductor film, a second metal layer (first conductive film), a first interlayer insulating film 33, a flattening film (first insulating film) 34, a first transparent electrode film, a second interlayer insulating film 35, a second transparent electrode film, and a second alignment film (alignment film) 36 are layered on the array substrate 21 in this order from a lower layer side. The first metal layer and the second metal layer are each formed as a single-layer film including one type of metal material or as a layered film or an alloy including different types of metal materials selected from copper, titanium, aluminum, molybdenum, tungsten, and the like, and thus, the first metal layer and the second metal layer have electrical conductivity and light blocking properties. The first metal layer constitutes the gate wiring line 26, the gate electrode 24A of the TFT 24, and the like. The second metal layer constitutes the source wiring line 27, the source electrode 24B and the drain electrode 24C of the TFT 24, and the like. The semiconductor film is formed of a thin film using, for example, an oxide semiconductor or amorphous silicon as the material thereof, and constitutes the semiconductor portion 24D and the like of the TFT 24. The first transparent electrode film and the second transparent electrode film are formed of a transparent electrode material (for example, indium tin oxide (ITO) or indium zinc oxide (IZO)). The first transparent electrode film constitutes a common electrode 37 and the like to be described later. The second transparent electrode film constitutes the pixel electrode 25 and the like. For example, the second alignment film 36, similarly to the first alignment film 31, is formed of polyimide or the like, and can align the liquid crystal molecules contained in the liquid crystal layer 22.

The gate insulating film 32, the first interlayer insulating film 33, and the second interlayer insulating film 35 are each formed of an inorganic material such as silicon nitride (SiNₓ) and silicon oxide (SiO₂). For example, the flattening film 34 is formed of an organic material such as PMMA (acrylic resin) and is photosensitive. That is, the flattening film 34 is formed of a photosensitive resin material. For example, the flattening film 34 has a film thickness of about 1 μm to 3 μm, which is significantly greater than the film thickness of the gate insulating film 32, the first interlayer insulating film 33, and the second interlayer insulating film 35. The flattening film 34 levels the inner surface of the array substrate 21 (a surface facing the counter substrate 20). The gate insulating film 32 maintains an insulated state between the first metal layer on the lower layer side and the semiconductor film and the second metal layer on the upper layer side. For example, an intersection location between the gate wiring line 26 including a part of the first metal layer and the source wiring line 27 including a part of the second metal layer is maintained in an insulated state by the gate insulating film 32. The first interlayer insulating film 33 and the flattening film 34 maintain an insulated state between the semiconductor film and the second metal layer on the lower layer side and the first transparent electrode film on the upper layer side. The second interlayer insulating film 35 maintains an insulated state between the first transparent electrode film on the lower layer side and the second transparent electrode film on the upper layer side.

As illustrated in FIG. 5, the common electrode 37 is disposed to extend over the entire region of the display region AA and overlap all of the pixel electrodes 25 disposed in the display region AA on the lower layer side. The common electrode 37 formed in a part of the first transparent electrode film and the pixel electrodes 25 each formed of a part of the second transparent electrode film are maintained in an insulated state by the second interlayer insulating film 35 interposed therebetween. A common potential (reference potential) is supplied to the common electrode 37 by a common wiring line (not illustrated). Accordingly, a potential difference based on the potential charged in the pixel electrode 25 may occur between the common electrode 37 and the pixel electrodes 25. The electrical field generated based on the potential difference between the common electrode 37 and the pixel electrodes 25 includes a fringe electrical field (oblique electrical field) including, in addition to a component along the main surface of the array substrate 21, a component in a normal direction with respect to the main surface of the array substrate 21. Accordingly, a display mode of the liquid crystal panel 11 according to the present embodiment is a so-called Fringe Field Switching (FFS) mode in which a fringe electrical field is utilized to control the alignment state of a liquid crystal included in the liquid crystal layer 22.

Next, a cross-sectional configuration of the TFT 24 will be described by referring mainly to FIG. 6. As illustrated in FIG. 6, the TFT 24 includes the gate electrode 24A formed by a part of the first metal layer. The gate electrode 24A is formed by locally widening a portion of the gate wiring line 26 in the vicinity of an intersection location of the gate wiring line 26 and the source wiring line 27 (see FIG. 3). The gate electrode 24A drives the TFT 24, based on a scanning signal supplied to the gate wiring line 26. The TFT 24 includes the source electrode 24B formed by a part of the second metal layer. The source electrode 24B is formed by locally widening a portion of the source wiring line 27 in the vicinity of an intersection location of the source wiring line 27 and the gate wiring line 26 (see FIG. 3). The source electrode 24B is disposed at one end of the TFT 24 in the X-axis direction. The source electrode 24B overlaps a part of the gate electrode 24A and is connected to the semiconductor portion 24D.

As illustrated in FIG. 6, the TFT 24 includes the drain electrode 24C formed by a part of the second metal layer. The drain electrode 24C is disposed at a position spaced apart from the source electrode 24B in the X-axis direction, that is, at the other end of the TFT 24 in the X-axis direction. An end portion of the drain electrode 24C on the side of the source electrode 24B is disposed so as to overlap a part of the gate electrode 24A and is connected to the semiconductor portion 24D. An end portion of the drain electrode 24C on a side opposite to the source electrode 24B is disposed to overlap the contact portion 25B of the pixel electrode 25. In the first flattening film 34, the second interlayer insulating film 35, and the first interlayer insulating film 33 interposed between the drain electrode 24C and the contact portion 25B, which overlap with each other, a contact hole CH is provided as a through-hole at a position overlapping the drain electrode 24C and the contact portion 25B. The contact portion 25B of the pixel electrode 25 is connected to the drain electrode 24C via the contact hole CH.

As illustrated in FIG. 6, the TFT 24 includes the semiconductor portion 24D having an island shape and including a channel portion. The semiconductor portion 24D has a horizontally elongated shape extending along the X-axis direction. The semiconductor portion 24D is disposed to overlap the gate electrode 24A. The semiconductor portion 24D formed by a part of the semiconductor film is maintained in an insulated state with respect to the gate electrode 24A formed by a part of the first metal layer, by the gate insulating film 32 interposed therebetween. One end side portion of the semiconductor portion 24D is connected to the source electrode 24B. The other end side portion of the semiconductor portion 24D is connected to the drain electrode 24C. A portion of the semiconductor portion 24D that overlaps the gate electrode 24A but does not overlap the source electrode 24B and the drain electrode 24C forms a channel portion functioning as a channel (current path). When the TFT 24 is in an on state based on a scanning signal supplied to the gate electrode 24A, an image signal (data signal) supplied to the source wiring line 27 is supplied from the source electrode 24B to the drain electrode 24C via the semiconductor portion 24D. As a result, the pixel electrode 25 is charged to a potential based on the image signal.

Next, a detailed configuration of the flattening film 34 will be described by referring to FIGS. 3, 6, and 7. As illustrated in FIGS. 3, 6, and 7, the flattening film 34 includes a first portion 34A, a second portion (main bump) 34B that is higher than the first portion 34A, and a third portion (sub-bump) 34C that is higher than the first portion 34A. That is, the flattening film 34 is formed so as to have a partially different film thickness (height). The flattening film 34 having a cross-sectional shape with a partially different film thickness is formed by using a photosensitive material as the organic material and by using a halftone exposure technique. Note that in FIG. 3, the range in which the second portion 34B and the third portion 34C are formed is hatched.

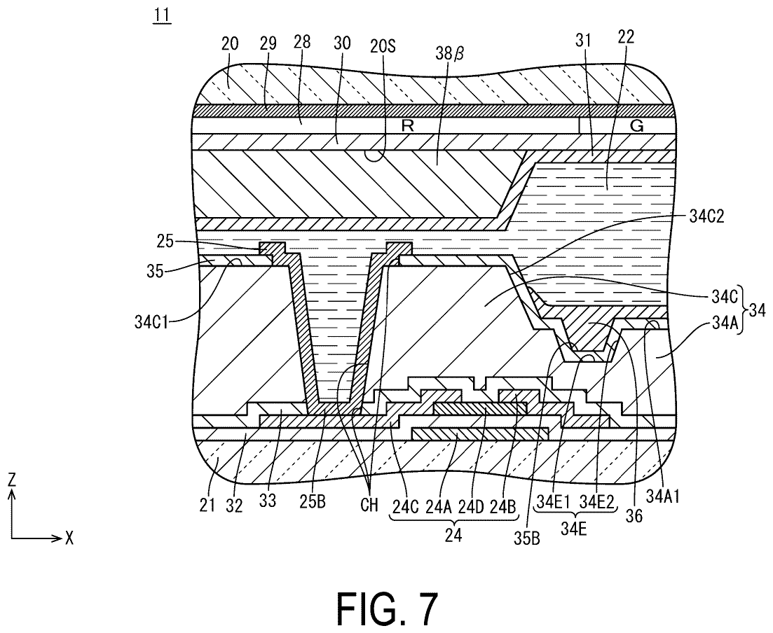

As illustrated in FIGS. 6 and 7, the first portion 34A has a first upper surface 34A1 as an upper surface. The first portion 34A is a portion of the flattening film 34 having a thinner film thickness than the second portion 34B and the third portion 34C, and the thickness of the first portion 34A is about 1.5 μm, for example. The first portion 34A is disposed in a region of the flattening film 34 where the second portion 34B and the third portion 34C are not arranged, and occupies most of the flattening film 34. Specifically, the first portion 34A is disposed in a range overlapping the main body portion 25A of the pixel electrode 25 and most of the source wiring line 27 excluding a portion intersecting the gate wiring line 26 (a range not overlapping a portion of the light blocking portion 29 extending along the X-axis direction in the counter substrate 20). The first upper surface 34A1 of the first portion 34A forms a second main surface serving as a reference surface of the array substrate 21.

As illustrated in FIGS. 6 and 7, the second portion 34B protrudes from the first upper surface 34A1 toward the counter substrate 20 (upward in FIGS. 6 and 7). The second portion 34B includes, as an upper surface, a second upper surface (protruding tip surface) 34B1 that is higher than the first upper surface 34A1. The second portion 34B has a tapered shape in which a protruding tip end portion is thinner than a protruding base end portion, and the second upper surface 34B1 is a plane in which the Z-axis direction is a normal line (a plane along the X-axis direction and the Y-axis direction) and a side surface (peripheral surface) 34B2 is an inclined surface inclined with respect to the Z-axis direction. The second portion 34B is a portion of the flattening film 34 having a thicker film thickness than the first portion 34A, and the thickness of the second portion 34B is about 2 μm, for example. The second portion 34B has a protruding dimension (a height dimension, a distance in the Z-axis direction between the first upper surface 34A1 and the second upper surface 34B1) from the first upper surface 34A1 of about 0.5 μm, for example. As illustrated in FIG. 3, the second portion 34B is disposed in the vicinity of an intersection location between a certain gate wiring line 26 and a certain source wiring line 27. That is, the second portion 34B is not disposed at all of the intersection locations of a plurality of the gate wiring lines 26 and a plurality of the source wiring lines 27, but is arranged in a dispersed manner with a predetermined distribution in the plane of the display region AA. Specifically, the second portion 34B is disposed so as to overlap a portion of a corresponding one of the source wiring lines 27 that is adjacent to the intersection location with the gate wiring line 26 (a portion that is continuous with the source electrode 24B). Furthermore, the second portion 34B is disposed to overlap the source electrode 24B of the TFT 24. The second portion 34B has a columnar shape that is substantially circular in a plan view. The second portion 34B has radial dimensions that are greater than the line width of the source wiring line 27 and is positioned to protrude to both the left and right sides of the source wiring line 27 in the X-axis direction.

As illustrated in FIGS. 6 and 7, the third portion 34C protrudes from the first upper surface 34A1 toward the counter substrate 20, similarly to the second portion 34B. The protruding dimension of the third portion 34C from the first upper surface 34A1 (a height dimension, a distance in the Z-axis direction between the first upper surface 34A1 and the third upper surface 34C1) is substantially equal to the protruding dimension of the second portion 34B (a distance in the Z-axis direction between the first upper surface 34A1 and the second upper surface 34B1), and is, for example, about 0.5 μm. The third portion 34C includes, as an upper surface, a third upper surface (protruding tip surface) 34C1 that is higher than the first upper surface 34A1. The third upper surface 34C1 has substantially the same height as the second upper surface 34B1. The third portion 34C has a tapered shape in which a protruding tip end portion is thinner than a protruding base end portion, and the third upper surface 34C1 is a plane in which the Z-axis direction is a normal line and a side surface 34C2 is an inclined surface inclined with respect to the Z-axis direction. The third portion 34C is a portion of the flattening film 34 having substantially the same film thickness as the second portion 34B, and the thickness of the third portion 34C is about 2 μm, for example. As illustrated in FIG. 3, the third portion 34C is disposed to overlap the TFT 24, the contact portion 25B of the pixel electrode 25, and a part of the gate wiring line 26 and the source wiring line 27 (an intersection location with the gate wiring line 26). The third portion 34C has a horizontally elongated columnar shape extending along the X-axis direction in a plan view. The third portion 34C is disposed over two pixels PX aligned along the X-axis direction, and overlaps two TFTs 24 and two contact portions 25B. The third portion 34C is arranged at an intersection location where the second portion 34B is not arranged, among the intersection locations of the plurality of gate wiring lines 26 and the plurality of source wiring lines 27. The third portion 34C is provided in a larger number than the second portion 34B.

As illustrated in FIGS. 4, 6, and 7, a spacer 38 protruding from the first main surface 20S toward the array substrate 21 is provided in the display region AA of the counter substrate 20. Similarly to the flattening film 34, the spacer 38 is formed of an organic material such as PMMA (acrylic resin). The spacers 38 are disposed at positions overlapping the second portions 34B and the third portions 34C of the flattening film 34 included in the array substrate 21 in a plan view. The number of spacers 38 being provided is equal to the sum of the number of the second portions 34B and the number of the third portions 34C. The spacers 38 indirectly contact the second portions 34B and the third portions 34C that overlap the spacers 38, and thus, can maintain a gap between the pair of substrates 20 and 21, that is, a cell gap (a thickness of the liquid crystal layer 22) so as not to take a certain value or less. Specifically, a portion overlapping the spacer 38 in the surface of the counter substrate 20 facing the array substrate 21, directly contacts a portion overlapping the second portion 34B and the third portion 34C in the surface of the array substrate 21 facing the counter substrate 20.

As illustrated in FIGS. 4, 6, and 7, the spacer 38 includes a first spacer (main spacer) 38α and a second spacer (sub-spacer) 38β having a smaller protruding dimension from the counter substrate 20 than the protruding dimension of the first spacer 38α. Note that, in the following description, when the spacers 38 are distinguished from each other, the suffix “α” is appended to the reference numeral of the first spacer, and the suffix “β” is appended to the reference numeral of the second spacer, and when the spacers 38 are collectively referred to without distinction, no suffix is appended to the reference numeral. As described above, the two types of spacers 38α and 38β having different heights are formed by using a photosensitive material as an organic material and using a halftone exposure technique.

As illustrated in FIGS. 6 and 7, the first spacer 38α has a greater protruding dimension from the first main surface 20S of the counter substrate 20 than the protruding dimension of the second spacer 38β. The first spacer 38α has a tapered shape in which a protruding tip end portion is formed thinner than a protruding base end portion. The first spacer 38α is disposed at a position overlapping the second portion 34B on the side of the array substrate 21 in a plan view. That is, the first spacer 38α is not disposed at all of the intersection locations of a plurality of the gate wiring lines 26 and a plurality of the source wiring lines 27, but is arranged in a dispersed manner with a predetermined distribution in the plane of the display region AA. The number of the first spacers 38α being provided is equal to the number of the second portions 34B being provided. In a state in which no external force or the like acts on the counter substrate 20 and the array substrate 21 and no deflection occurs in both the counter substrate 20 and the array substrate 21 (a state in which the thickness of the liquid crystal layer 22 is a design value), a portion overlapping the first spacer 38α in the surface of the counter substrate 20 facing the array substrate 21, and a portion overlapping the second portion 34B in the surface of the array substrate 21 facing the counter substrate 20, contact each other. That is, the first spacer 38α is maintained in a state in which the first spacer 38α always indirectly contacts the inner surface (the second alignment film 36) of the array substrate 21, and thus, the gap between the pair of substrates 20 and 21 is maintained in a preferred manner. As illustrated in FIG. 4, the first spacer 38α has a columnar shape that is substantially circular in a plan view.

As illustrated in FIGS. 6 and 7, the second spacer 38β has a smaller protruding dimension from the first main surface 20S of the counter substrate 20 than the protruding dimension of the first spacer 38α. The second spacer 38β has a tapered shape in which a protruding tip end portion is thinner than a protruding base end portion. The second spacer 38β is disposed at a position overlapping the third portion 34C on the side of the array substrate 21 in a plan view. The number of the second spacers 38β being provided is equal to the number of the third portions 34C being provided. Therefore, the number of the second spacers 38β being provided is greater than the number of the first spacers 38α being provided. In a state in which no deflection occurs in both the counter substrate 20 and the array substrate 21 (a state in which the thickness of the liquid crystal layer 22 is a design value), a gap (clearance) is formed between a portion overlapping the second spacer 38β in the surface of the counter substrate 20 facing the array substrate 21, and a portion overlapping the third portion 34C in the surface of the array substrate 21 facing the counter substrate 20, and the portions do not contact each other. On the other hand, in a state in which an external force acts on any one or both of the counter substrate 20 and the array substrate 21 and a deflection occurs (a state in which the thickness of the liquid crystal layer 22 is smaller than the design value), a portion overlapping the second spacer 38β in the surface of the counter substrate 20 facing the array substrate 21, and a portion overlapping the third portion 34C in the surface of the array substrate 21 facing the counter substrate 20, contact each other. Thereby, further deflection of any one or both of the substrates 20 and 21 is regulated. As described above, the thickness of the liquid crystal layer 22, that is, the cell gap, can be maintained by the first spacer 38α and the second spacer 38β. As illustrated in FIG. 4, the second spacer 38β has a horizontally elongated columnar shape extending along the X-axis direction in a plan view.

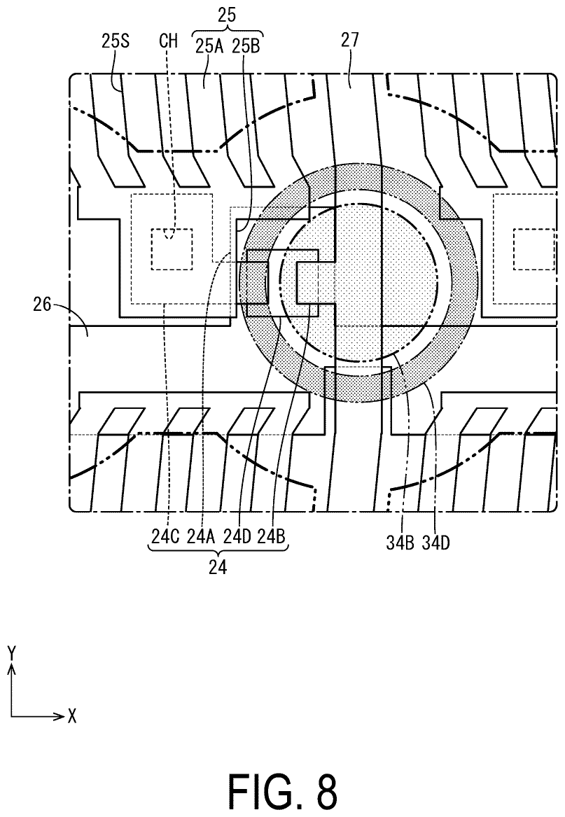

In the present embodiment, as illustrated in FIGS. 6 and 8, a first groove portion (groove portion) 34D disposed so as to surround the second portion 34B is provided in the first portion 34A of the flattening film 34. The flattening film 34 having a cross-sectional shape in which the first groove portion 34D is provided in a part of the first portion 34A is formed by using a photosensitive material as an organic material and by using a halftone exposure technique. Note that, in FIGS. 3 and 8, the range in which the first groove portion 34D is formed is hatched differently from the second portion 34B and the third portion 34C.

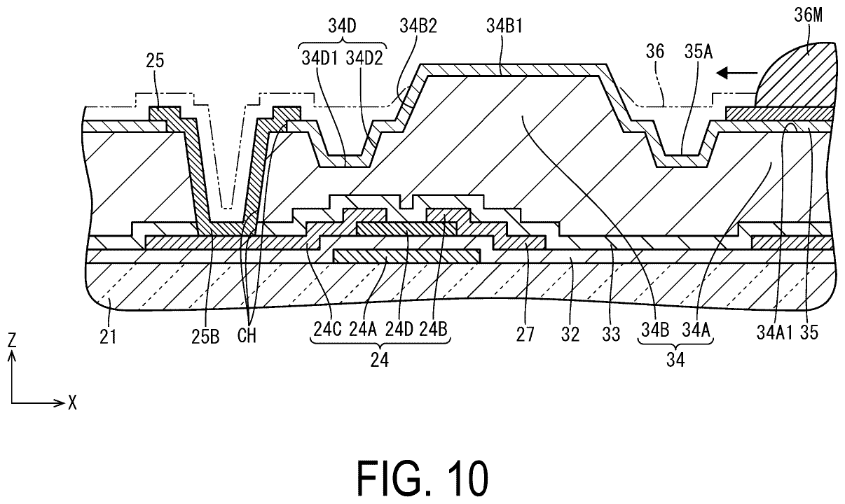

As illustrated in FIG. 6, the configuration is such that the cross-sectional shape of the flattening film 34 serving as an underlayer is reflected on the cross-sectional shape of the third interlayer insulating film 35 disposed on the upper layer side of the flattening film 34. Specifically, a portion of the third interlayer insulating film 35 overlapping the second portion 34B and the third portion 34C is higher than a portion overlapping the first portion 34A (see FIG. 7). A portion of the third interlayer insulating film 35 overlapping the first groove portion 34D in a plan view forms a first recess 35A that is lower than a portion of the first portion 34A overlapping the first upper surface 34A1 (a portion other than the first groove portion 34D) in a plan view. When the second alignment film 36, which is disposed at an upper layer side of the third interlayer insulating film 35 and is located in the uppermost layer in the array substrate 21, is formed by film formation, a material 36M of the second alignment film 36 flows and spreads along the first upper surface 34A1 of the first portion 34A in the flattening film 34 (see FIG. 10). The first groove portion 34D which is disposed so as to surround the second portion 34B, is provided in the first portion 34A of the flattening film 34. Therefore, the material 36M of the second alignment film 36 flowing along the first upper surface 34A1 is easily retained in the first recess 35A which is a space generated by the first groove portion 34D before reaching the second portion 34B. Therefore, the material 36M of the second alignment film 36 is less likely to reach a position overlapping the second upper surface 34B1 of the second portion 34B, and thus, the second alignment film 36 is very likely not to be formed at the position overlapping the second upper surface 34B1 of the second portion 34B. Accordingly, even when a portion overlapping the first spacer 38α in the surface of the counter substrate 20 facing the array substrate 21 and a portion overlapping the second upper surface 34B1 of the second portion 34B in the surface of the array substrate 21 facing the counter substrate 20, contact each other and generate friction, the second alignment film 36 is less likely to be scraped off. As a result, suspended foreign matter is less likely to be generated and deterioration of the display quality is suppressed.

As illustrated in FIG. 8, the first groove portion 34D has an annular planar shape and surrounds the entire periphery of the second portion 34B. Specifically, the first groove portion 34D has a substantially circular planar shape, and has a similar shape to the planar shape of the second portion 34B. That is, the first groove portion 34D is provided so as to extend along the planar shape of the second portion 34B. The first groove portion 34D is disposed concentrically with the second portion 34B in a plan view. The first groove portion 34D is disposed at a position spaced apart from an outer peripheral end portion of the second portion 34B. Specifically, an inner diameter dimension of the first groove portion 34D is greater than the maximum diameter dimension of the second portion 34B (a radial dimension of the protruding base end portion). Accordingly, a substantially constant gap (a gap corresponding to about the differential between an inner diameter dimension of the first groove portion 34D and the maximum diameter dimension of the second portion 34B) is formed over the entire periphery between an inner peripheral end portion of the first groove portion 34D and an outer peripheral end portion of the second portion 34B.

As described above, the first groove portion 34D has an annular shape surrounding the entire periphery of the second portion 34B. Therefore, the material 36M of the second alignment film 36 flowing along the first upper surface 34A1 during the film formation of the second alignment film 36 is more reliably retained in the first recess 35A, which is a space generated by the first groove portion 34D, regardless of the orientation in which the material 36M is present with respect to the second portion 34B in the circumferential direction of the second portion 34B. Thus, the material 36M of the second alignment film 36 is less likely to reach a position overlapping the second upper surface 34B1 of the second portion 34B. Furthermore, the first groove portion 34D extends along the planar shape of the second portion 34B, and thus, an arrangement space of the first groove portion 34D disposed so as to surround the second portion 34B can be minimized.

Moreover, as illustrated in FIG. 6, the first groove portion 34D is provided by partially recessing the first portion 34A, and includes a bottom surface 34D1. Accordingly, a portion of the first portion 34A where the first groove portion 34D is formed is locally thinner than a portion where the first groove portion 34D is not formed. In other words, the depth of the first groove portion 34D is smaller than the thickness of the first portion 34A. Specifically, the depth of the first groove portion 34D is, for example, about 1 μm, which is smaller than the thickness of the first portion 34A, which is about 1.5 μm. Therefore, the depth of the first groove portion 34D is greater than the protruding dimension (about 0.5 μm) of the second portion 34B from the first upper surface 34A1. In other words, the distance between the bottom surface 34D1 of the first groove portion 34D and the first upper surface 34A1 of the first portion 34A in the Z-axis direction (for example, about 1 μm) is greater than the distance between the first upper surface 34A1 of the first portion 34A and the second upper surface 34B1 of the second portion 34B in the Z-axis direction (for example, about 0.5 μm). As described above, the first groove portion 34D does not extend through the first portion 34A, and thus, structural elements (for example, the source electrode 24B, the drain electrode 24C, and the like) present below the first portion 34A can be protected by a portion of the first portion 34A including the bottom surface 34D1 of the first groove portion 34D. The first groove portion 34D is formed so as to become narrower at a deeper position, and a side surface 34D2 of the first groove portion 34D forms an inclined surface that is inclined with respect to the Z-axis direction.

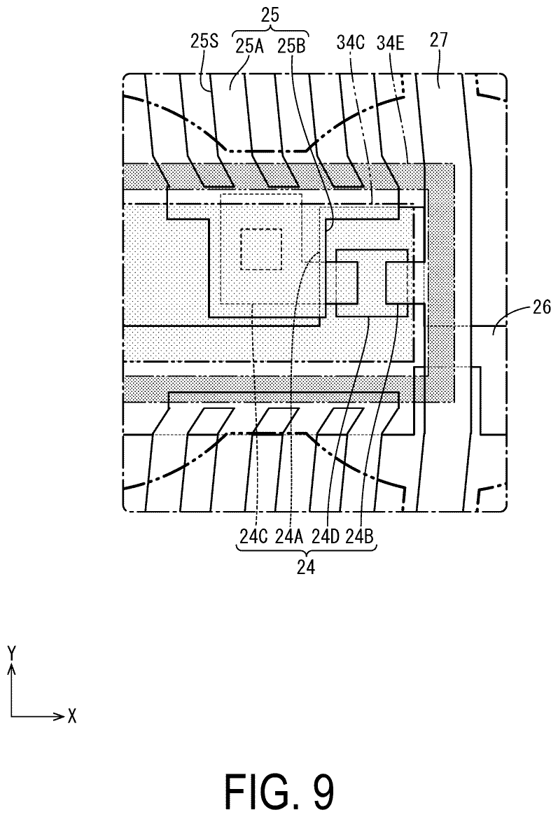

As illustrated in FIGS. 3, 7, and 9, the first portion 34A of the flattening film 34 includes a second groove portion 34E disposed so as to surround the third portion 34C. Note that, in FIGS. 3 and 9, the range in which the second groove portion 34E is formed is hatched differently from the second portion 34B and the third portion 34C. As illustrated in FIG. 7, the cross-sectional shape of the flattening film 34 serving as an underlayer is reflected on the cross-sectional shape of the third interlayer insulating film 35 disposed on the upper layer side of the flattening film 34. A portion of the third interlayer insulating film 35 overlapping the second groove portion 34E in a plan view serves as a second recess 35B that is lower than a portion of the first portion 34A overlapping the first upper surface 34A1 (a portion other than the first groove portion 34D and the second groove portion 34E) in a plan view. Accordingly, when the second alignment film 36 is formed by film formation, the material 36M of the second alignment film 36 flowing along the first upper surface 34A1 of the first portion 34A is easily retained in the second recess 35B which is a space generated by the second groove portion 34E before reaching the third portion 34C. Therefore, the material 36M of the second alignment film 36 is less likely to reach a position overlapping the third upper surface 34C1 of the third portion 34C, and thus, the second alignment film 36 is very likely not to be formed at the position overlapping the third upper surface 34C1 of the third portion 34C. Accordingly, even when a portion overlapping the second spacer 38β in the surface of the counter substrate 20 facing the array substrate 21 and a portion overlapping the third upper surface 34C1 of the third portion 34C in the surface of the array substrate 21 facing the counter substrate 20, contact each other and generate friction, the second alignment film 36 is less likely to be scraped off. As a result, suspended foreign matter is less likely to be generated and deterioration of the display quality is suppressed.

As illustrated in FIGS. 3 and 9, the second groove portion 34E has an annular planar shape and surrounds the entire periphery of the third portion 34C. Specifically, the second groove portion 34E has a rectangular frame-like shape in a plan view, and has a similar shape to the planar shape of the third portion 34C. That is, the second groove portion 34E is provided so as to extend along the planar shape of the third portion 34C. The second groove portion 34E is disposed concentrically with the third portion 34C in a plan view. The second groove portion 34E is disposed at a position spaced apart from an outer peripheral end portion of the third portion 34C. Specifically, inner dimensions of the second groove portion 34E in the X-axis direction and the Y-axis direction thereof are greater than the maximum outer dimensions (outer dimensions of the protruding base end portion) of the third portion 34C in the X-axis direction and the Y-axis direction, respectively. Accordingly, a substantially constant gap (a gap corresponding to about the differential between an inner dimension of the second groove portion 34E and the maximum outer dimension of the third portion 34C) is formed over the entire periphery between an inner peripheral end portion of the second groove portion 34E and an outer peripheral end portion of the third portion 34C.

As described above, the second groove portion 34E has an annular shape surrounding the entire periphery of the third portion 34C. Therefore, the material 36M of the second alignment film 36 flowing along the first upper surface 34A1 during the film formation of the second alignment film 36 is more reliably retained in the second recess 35B, which is a space generated by the second groove portion 34E, regardless of the orientation in which the material 36M is present with respect to the third portion 34C in the circumferential direction of the third portion 34C. Thus, the material 36M of the second alignment film 36 is less likely to reach a position overlapping the third upper surface 34C1 of the third portion 34C. Furthermore, the first groove portion 34D extends along the planar shape of the third portion 34C, and thus, an arrangement space of the second groove portion 34E disposed so as to surround the third portion 34C can be minimized.

Moreover, as illustrated in FIG. 7, the second groove portion 34E is provided by partially recessing the first portion 34A, and includes a bottom surface 34E1. Accordingly, a portion of the first portion 34A where the second groove portion 34E is formed is locally thinner than a portion where the second groove portion 34E is not formed. In other words, the depth of the second groove portion 34E is smaller than the thickness of the first portion 34A. Specifically, the depth of the second groove portion 34E is, for example, about 1 μm, which is similar to the depth of the first groove portion 34D and smaller than the thickness of the first portion 34A, which is about 1.5 μm. Therefore, the depth of the second groove portion 34E is greater than the protruding dimension (about 0.5 μm) of the third portion 34C from the first upper surface 34A1. In other words, the distance between the bottom surface 34E1 of the second groove portion 34E and the first upper surface 34A1 of the first portion 34A in the Z-axis direction (for example, about 1 μm) is greater than the distance between the first upper surface 34A1 of the first portion 34A and the third upper surface 34C1 of the third portion 34C in the Z-axis direction (for example, about 0.5 μm). As described above, the second groove portion 34E does not extend through the first portion 34A, and thus, structural elements (for example, the source electrode 24B, the drain electrode 24C, and the like) present below the first portion 34A can be protected by a portion of the first portion 34A including the bottom surface 34E1 of the second groove portion 34E. The second groove portion 34E is formed so as to become narrower at a deeper position, and a side surface 34E2 of the second groove portion 34E forms an inclined surface that is inclined with respect to the Z-axis direction.

The liquid crystal panel 11 according to the present embodiment has the above-described structure, and a manufacturing method thereof will be subsequently described. The manufacturing method of the liquid crystal panel 11 includes a counter substrate manufacturing step (counter substrate manufacturing step) of manufacturing the counter substrate 20, an array substrate manufacturing step (array substrate manufacturing step) of manufacturing the array substrate 21, and a bonding step of bonding the manufactured counter substrate 20 and the array substrate 21 together. Hereinafter, among the above steps, the array substrate manufacturing step will be described.

The array substrate manufacturing step includes at least a first step of forming a first metal layer by film formation and patterning the first metal layer, a second step of forming the gate insulating film 32 by film formation, a third step of forming a semiconductor film by film formation and patterning the semiconductor film, a fourth step of forming a second metal layer by film formation and patterning the second metal layer, a fifth step of forming, by film formation, the first interlayer insulating film 33 and the flattening film 34 and patterning the first interlayer insulating film 33 and the flattening film 34, a sixth step of forming a first transparent electrode film by film formation and patterning the first transparent electrode film, a seventh step of forming the second interlayer insulating film 35 by film formation and patterning the second interlayer insulating film 35, an eighth step of forming a second transparent electrode film by film formation and patterning the second transparent electrode film, and a ninth step of forming the second alignment film 36 by film formation.

The term “patterning” mentioned above means that each film is subjected to a process based on a general photolithography method. Specifically, the process, that is, the patterning of a film to be processed is performed by performing the film formation of a photoresist film on the film to be processed, exposing the photoresist film with an exposure device through a photomask having a predetermined opening pattern, and then developing the photoresist film, and performing etching through the developed photoresist film.

The fifth step and the ninth step included in the array substrate manufacturing step will be described below. In the fifth step, after the first interlayer insulating film 33 is formed by film formation on the upper layer side of the second metal layer patterned in the fourth step, the flattening film (photosensitive resin film) 34 formed of a photosensitive resin material is subsequently applied (see FIGS. 6 and 7). Thereafter, an exposure device and a photomask are used to expose the flattening film 34 which is a photosensitive resin film. Here, a positive photosensitive resin film is used as the flattening film 34. The photomask used herein is a so-called halftone mask. The halftone mask includes at least a light blocking film that blocks exposure light emitted from an exposure device and a transflective film that transmits the exposure light at a predetermined transmittance. The light blocking film has a predetermined opening pattern. The transflective film is provided at least in a predetermined range of the opening pattern of the light blocking film, and has two different film thicknesses in accordance with the range. That is, the transflective film includes a first film thickness portion and a second film thickness portion having a smaller film thickness than the first film thickness portion. In the second film thickness portion, a larger amount of exposure light is transmitted than in the first film thickness portion. The light blocking film forms a light blocking region of the photomask, and is in a relationship of overlapping with a range where the second portion 34B and the third portion 34C of the flattening film 34 are to be formed. A portion of the opening pattern of the light blocking film where the transflective film is not formed constitutes a transmissive region of the photomask, and is in a relationship of overlapping with a range where the contact hole CH of the flattening film 34 is to be formed. A portion of the opening pattern of the light blocking film where the first film thickness portion of the transflective film is formed constitutes a first transflective region of the photomask, and is in a relationship of overlapping with a range of the flattening film 34 where the first portion 34A is to be formed. A portion of the opening pattern of the light blocking film where the second film thickness portion of the transflective film is formed constitutes a second transflective region of the photomask, and is in a relationship of overlapping with a range of the flattening film 34 where the first groove portion 34D and the second groove portion 34E are to be formed. As described above, the photomask used to perform exposure in the fifth step is a four-tone halftone mask.

In the fifth step, the flattening film 34, which is a photosensitive resin film, is irradiated with exposure light from the exposure device via the photomask having the above-described configuration. Thus, a range of the flattening film 34 overlapping the light blocking region of the photomask is not irradiated with the exposure light. However, a range of the flattening film 34 overlapping a transmissive region of the photomask is irradiated with the exposure light at the maximum intensity, a range of the flattening film 34 overlapping the first transflective region of the photomask is irradiated with the exposure light having a smaller light amount than that of the second transflective region, and a range of the flattening film 34 overlapping the second transflective region of the photomask is irradiated with the exposure light having a light amount that is greater than that of the first transflective region and smaller than that of the transmissive region. When the flattening film 34 is developed after the exposure, a part corresponding to a thickness in accordance with the exposure amount is removed from an exposed portion of the flattening film 34. Specifically, the range of the flattening film 34 overlapping the light blocking region of the photomask is not removed. However, the entire depth of the range of the flattening film 34 overlapping the transmissive region of the photomask is removed, the range of the flattening film 34 overlapping the first transflective region of the photomask is removed at a shallower depth than the range overlapping the second transflective region, and the range of the flattening film 34 overlapping the second transflective region of the photomask is removed at a deeper depth than the range overlapping the first transflective region. The range of the flattening film 34 overlapping the light blocking region of the photomask is not removed, and thus, the film thickness of the second portion 34B and the third portion 34C is the maximum thickness. The entire depth of a range of the flattening film 34 overlapping the transmissive region of the photomask is removed, and a part of the contact hole CH is formed. The range of the flattening film 34 overlapping the first transflective region of the photomask is removed at a shallower depth than the range overlapping the second transflective region of the photomask, and forms the first portion 34A. The range of the flattening film 34 overlapping the second transflective region of the photomask is removed at a deeper depth than the range overlapping the first transflective region of the photomask, and thus, the first groove portion 34D and the second groove portion 34E are formed.

Subsequently, the first interlayer insulating film 33 is etched via the flattening film 34 remaining after the development. Thus, the entire depth of a range of the first interlayer insulating film 33 overlapping an opening portion (a part of the contact hole CH) of the flattening film 34 is removed. Therefore, the contact hole CH is formed that communicates with the first interlayer insulating film 33 and the flattening film 34.

In the ninth step, as illustrated in FIG. 10, the material 36M of the second alignment film 36 is supplied in a liquid state to the upper layer side of the second transparent electrode film patterned in the eighth step. As a means for supplying the material 36M of the second alignment film 36, an ink-jet device or the like can be used, for example. The material 36M of the second alignment film 36 is adjusted so as to have a predetermined viscosity and has fluidity. On the upper layer side of the second transparent electrode film, the supplied material 36M of the second alignment film 36 flows along the first upper surface 34A1 of the first portion 34A, which is the main portion of the flattening film 34, and spreads on the surface. Here, the first groove portion 34D disposed so as to surround the second portion 34B, is provided in the first portion 34A of the flattening film 34. Therefore, the material 36M of the second alignment film 36 flowing along the first upper surface 34A1 is easily retained in the first recess 35A which is a space generated by the first groove portion 34D before reaching the second portion 34B. Accordingly, the material 36M of the second alignment film 36 is less likely to reach a position overlapping the second upper surface 34B1 of the second portion 34B, and thus, the second alignment film 36 is very likely not to be formed at the position overlapping the second upper surface 34B1 of the second portion 34B. Similarly, the second groove portion 34E disposed so as to surround the third portion 34C, is provided in the first portion 34A of the flattening film 34. Therefore, the material 36M of the second alignment film 36 flowing along the first upper surface 34A1 of the first portion 34A is easily retained in the second recess 35B which is a space generated by the second groove portion 34E before reaching the third portion 34C. Accordingly, the material 36M of the second alignment film 36 is less likely to reach a position overlapping the third upper surface 34C1 of the third portion 34C, and thus, the second alignment film 36 is very likely not to be formed at the position overlapping the third upper surface 34C1 of the third portion 34C.

As described above, the liquid crystal panel (display device) 11 of the present embodiment includes the counter substrate (first substrate) 20, the array substrate (second substrate) 21 facing the counter substrate 20 with a gap therebetween, the first spacer 38α provided in the counter substrate 20 and protruding from the counter substrate 20 toward the array substrate 21, the second alignment film (alignment film) 36 provided in the array substrate 21 and located in the uppermost layer, and the flattening film (first insulating film) 34 provided in the array substrate 21 and disposed on the lower layer side from the second alignment film 36. The flattening film 34 includes the first portion 34A having the first upper surface 34A1 as an upper surface and the second portion 34B having the second upper surface 34B1 that is higher than the first upper surface 34A1 as an upper surface. The second portion 34B is disposed to overlap the first spacer 38α. The first portion 34A includes the first groove portion (groove portion) 34D disposed so as to surround the second portion 34B.

A portion overlapping the first spacer 38α in the surface of the counter substrate 20 facing the array substrate 21 may contact a portion overlapping the second upper surface 34B1 of the second portion 34B in the surface of the array substrate 21 facing the counter substrate 20. This ensures that the gap (cell gap) between the counter substrate 20 and the array substrate 21 facing each other is maintained in a preferred manner. Here, when the second alignment film 36 located in the uppermost layer in the array substrate 21 is formed by film formation, the material 36M of the second alignment film 36 flows and spreads along the first upper surface 34A1 of the first portion 34A in the flattening film 34. The first groove portion 34D disposed so as to surround the second portion 34B, is provided in the first portion 34A of the flattening film 34. Therefore, the material 36M of the second alignment film 36 flowing along the first upper surface 34A1 is easily retained in the space generated by the first groove portion 34D before reaching the second portion 34B. Therefore, the material 36M of the second alignment film 36 is less likely to reach a position overlapping the second upper surface 34B1 of the second portion 34B, and thus, it is likely that the second alignment film 36 is not formed at the position overlapping the second upper surface 34B1 of the second portion 34B. Accordingly, even when a portion overlapping the first spacer 38α in the surface of the counter substrate 20 facing the array substrate 21 and a portion overlapping the second upper surface 34B1 of the second portion 34B in the surface of the array substrate 21 facing the counter substrate 20, contact each other and generate friction, the second alignment film 36 is less likely to be scraped off. As a result, suspended foreign matter is less likely to be generated and deterioration of the display quality is suppressed.

The first groove portion 34D has an annular shape surrounding the entire periphery of the second portion 34B. The material 36M of the second alignment film 36 flowing along the first upper surface 34A1 is more reliably retained in the first recess 35A, which is a space generated by the first groove portion 34D, regardless of the orientation in which the material 36M is present with respect to the second portion 34B in the circumferential direction of the second portion 34B. Thus, the material 36M of the second alignment film 36 is less likely to reach a position overlapping the second upper surface 34B1 of the second portion 34B.

The first groove portion 34D extends along the planar shape of the second portion 34B. An arrangement space of the first groove portion 34D disposed so as to surround the second portion 34B can be minimized.

The first groove portion 34D has a recessed shape including the bottom surface 34D1. The first groove portion 34D does not extend through the first portion 34A, and thus, structural elements present below the first portion 34A can be protected by a portion of the first portion 34A including the bottom surface 34D1 of the first groove portion 34D.

The second spacer 38β is provided in the counter substrate 20 and protrudes from the counter substrate 20 toward the array substrate 21. The second spacer 38β has a smaller protruding dimension from the counter substrate 20 than the protruding dimension of the first spacer 38α. The flattening film 34 includes the third portion 34C having, as an upper surface, the third upper surface 34C1 that is higher than the first upper surface 34A1 and has the same height as the second upper surface 34B1 or is lower than the second upper surface 34B1. The third portion 34C is disposed to overlap the second spacer 38β. A portion overlapping the first spacer 38α in the surface of the counter substrate 20 facing the array substrate 21, contacts a portion overlapping the second portion 34B in the surface of the array substrate 21 facing the counter substrate 20.

The second spacer 38β has a smaller protruding dimension from the counter substrate 20 than the protruding dimension of the first spacer 38α, and the third portion 34C overlapping the second spacer 38β includes the third upper surface 34C1 that is higher than the first upper surface 34A1 and has the same height as the second upper surface 34B1 or is lower than the second upper surface 34B1. Accordingly, a gap is formed between a portion overlapping the first spacer 38α in the surface of the counter substrate 20 facing the array substrate 21, and a portion overlapping the third upper surface 34C1 of the third portion 34C in the surface of the array substrate 21 facing the counter substrate 20. Therefore, for example, when an external force acts on the counter substrate 20 or the array substrate 21 and a deflection occurs in the counter substrate 20 or the array substrate 21, the portion overlapping the first spacer 38α in the surface of the counter substrate 20 facing the array substrate 21 may contact a portion overlapping the third upper surface 34C1 of the third portion 34C in the surface of the array substrate 21 facing the counter substrate 20. In contrast, even in a state in which no external force or the like acts on the counter substrate 20 or the array substrate 21, the portion overlapping the first spacer 38α in the surface of the counter substrate 20 facing the array substrate 21, contacts a portion overlapping the second upper surface 34B1 of the second portion 34B in the surface of the array substrate 21 facing the counter substrate 20. Thus, the second alignment film 36 may be scraped off due to friction. Therefore, as described above, the first groove portion 34D disposed so as to surround the second portion 34B is provided in the first portion 34A of the flattening film 34, so that the second alignment film 36 is likely not to be formed at a position overlapping the second upper surface 34B1 of the second portion 34B. Thus, even when friction is generated, the second alignment film 36 is less likely to be scraped off.

### Second Embodiment

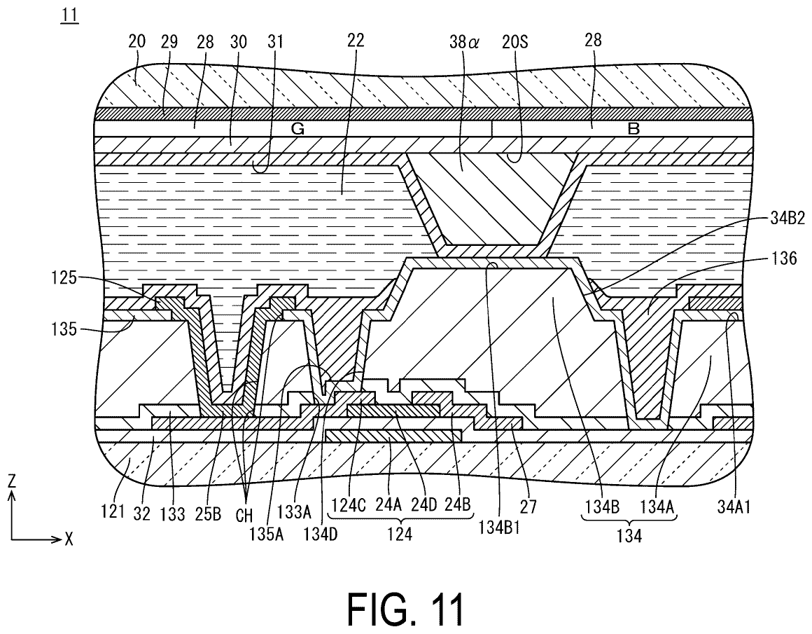

A second embodiment will be described with reference to FIG. 11. In the second embodiment, an alternative configuration including a first groove portion 134D will be described. Further, repetitive descriptions of structures, actions, and effects similar to those of the first embodiment described above will be omitted.

As illustrated in FIG. 11, the first groove portion 134D according to the present embodiment is provided to extend through a first portion 134A of a flattening film 134. That is, the first groove portion 134D is provided over the entire depth range of the first portion 134A. The depth of a first recess 135A generated in a portion of a third interlayer insulating film 135 overlapping the first groove portion 134D in a plan view is greater than the depth of the first recess 35A described in the first embodiment above (see FIG. 6). Therefore, the amount of the material 36M of a second alignment film 136 retained in the first recess 135A, which is a space formed by the first groove portion 134D, can be increased, compared to the first embodiment. Thus, the material 36M of the second alignment film 136 is less likely to reach a position overlapping a second upper surface 134B1 of a second portion 134B.

Furthermore, in the present embodiment, an opening portion 133A communicating with the first groove portion 134D is provided in a first interlayer insulating film 133 at a position overlapping the first groove portion 134D. The opening portion 133A is provided to extend through the first interlayer insulating film 133. Accordingly, the first recess 135A formed in the portion of the third interlayer insulating film 135 overlapping the first groove portion 134D in a plan view has a depth reflecting, in addition to the first groove portion 134D extending through the flattening film 134, the opening portion 133A extending through the first interlayer insulating film 133. Therefore, the first recess 135A has a depth corresponding to the sum of the film thickness of the first flattening film 134 and the film thickness of the first interlayer insulating film 133, and thus, the amount of the material 36M of the second alignment film 136 retained in the first recess 135A can be further increased. Thus, the material 36M of the second alignment film 136 is less likely to reach a position overlapping the second upper surface 134B1 of the second portion 134B. Note that the second groove portion 34E is also provided to extend through the flattening film 134, and further, an opening portion is provided to extend through the first interlayer insulating film 133 at a position overlapping the second groove portion 34E, which is not illustrated in the drawings.

In the present embodiment, it can be stated that the first groove portion 134D extending through the flattening film 134 and the opening portion 133A extending through the first interlayer insulating film 133 have a configuration similar to the contact hole CH provided to extend through each of the first interlayer insulating film 133 and the flattening film 134. Therefore, a three-tone halftone mask can be used as a photomask to perform exposure in the fifth step included in the array substrate manufacturing process. Specifically, the photomask used to perform exposure in the fifth step includes a light blocking region overlapping a range of the flattening film 134 where the second portion 134B and the third portion 34C are to be formed, a transmissive region overlapping a range of the flattening film 134 where the contact hole CH, the first groove portion 134D, and the second groove portion 34E are to be formed, and a transflective region overlapping a range of the flattening film 134 where the first portion 134A is to be formed. Accordingly, the photomask according to the present embodiment has a simpler configuration than the photomask according to the first embodiment, and is easy to manufacture. In the fifth step, the flattening film 134, which is a photosensitive resin film, is exposed and developed via the photomask having the above-described configuration and the first interlayer insulating film 133 is etched via the patterned flattening film 134. Thus, the contact hole CH extending through the first interlayer insulating film 133 and the flattening film 134, the first groove portion 134D extending through the flattening film 134, and the opening portion 133A extending through the first interlayer insulating film 133 can be provided in one process.

As described above, according to the present embodiment, the first groove portion 134D is provided to extend through the first portion 134A. The depth of the first groove portion 134D is maximized, and thus, the amount of the material 36M of the second alignment film 136 retained in the space formed by the first groove portion 134D can be maximized. Thus, the material 36M of the second alignment film 136 is less likely to reach a position overlapping the second upper surface 134B1 of the second portion 134B.

Furthermore, a thin film transistor (TFT) 124 provided in an array substrate 121 and a pixel electrode 125 provided in the array substrate 121 and connected to the TFT 124 are provided. The TFT 124 includes a drain electrode (first electrode) 124C disposed on a lower layer side of the flattening film 134 and disposed to overlap a part of each of the pixel electrode 125 and the first portion 134A, and the contact hole CH connecting the drain electrode 124C and the pixel electrode 125 is provided to extend through the first portion 134A at a position overlapping both the drain electrode 124C and the pixel electrode 125. The drain electrode 124C of the TFT 124 is connected to the pixel electrode 125 via the contact hole CH provided to extend through the first portion 134A of the flattening film 134. The first groove portion 134D and the contact hole CH are both provided to extend through the first portion 134A. Accordingly, compared to a case in which the first groove portion 134D does not extend through the first portion 134A, the flattening film 134 can be easily processed when the array substrate 121 is manufactured.

### Third Embodiment

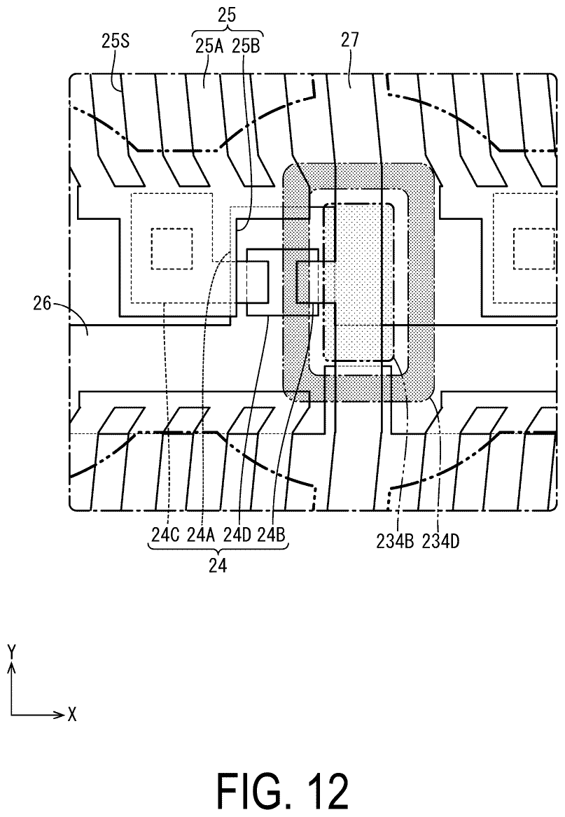

A third embodiment will be described with reference to FIG. 12. The third embodiment describes a case in which a configuration of a second portion 234B is changed from that of the first embodiment described above. Further, repetitive descriptions of structures, actions, and effects similar to those of the first embodiment described above will be omitted.

As illustrated in FIG. 12, the second portion 234B according to the present embodiment has a vertically elongated, substantially rectangular shape in a plan view. Note that, similarly to the second portion 234B, the planar shape of the first spacer 38α overlapping the second portion 234B is a vertically elongated, substantially rectangular shape, which is not illustrated in the drawing. Accordingly, a first groove portion 234D has a vertically elongated rectangular frame-like shape in a plan view, and has a shape similar to that of the second portion 234B. According to such a configuration, it is also possible to obtain actions and effects similar to those of the above-described first embodiment.

### Other Embodiments

The techniques disclosed herein are not limited to the embodiments described above and illustrated in the drawings, and the following embodiments, for example, are also included within the technical scope.

(1) The first groove portion 34D, 134D, 234D may extend so as not to follow the outer shape of the second portion 34B, 134B, 234B. That is, there may be a relationship such that the planar shape of the first groove portion 34D, 134D, 234D is not similar to the planar shape of the second portions 34B, 134B, 234B. For example, the planar shape of the second portion 34B, 134B, 234B may be circular, whereas the planar shape of the first groove portion 34D, 134D, 234D may be a rectangular frame-like shape. Similarly, there may be a relationship such that the planar shape of the second groove portion 34E is not similar to the planar shape of the third portion 34C.

(2) The planar shape of the second portion 34B, 134B, 234B may be appropriately changed to a shape other than the shape illustrated in the drawings. For example, the planar shape of the second portion 34B, 134B, 234B may be an elliptical shape, a horizontally elongated rectangle, a triangle, a square, a rhombus, a parallelogram, a polygon having five or more sides, and the like. The planar shape of the first groove portion 34D, 134D, 234D may be similar to or may not be similar to the planar shape of the second portion 34B, 134B, 234B. The planar shape of the second groove portion 34E may be appropriately changed to a shape other than the shape illustrated in the drawings.

(3) The first groove portion 34D, 134D, 234D may have a non-annular planar shape and may not surround the entire periphery of the second portion 34B, 134B, 234B. That is, the planar shape of the first groove portion 34D, 134D, 234D may be an open-ended annular shape, and even in this case, the first groove portion 34D, 134D, 234D can surround the second portion 34B, 134B, 234B over a predetermined range. For example, the planar shape of the second portion 34B, 134B, 234B may be circular, whereas the planar shape of the first groove portion 34D, 134D, 234D may be substantially C-shaped. The second groove portion 34E may also have a configuration similar to the configuration described above.

(4) A plurality of the first groove portions 34D, 134D, 234D may be disposed side by side at intervals along the circumferential direction of the second portion 34B, 134B, 234B. For example, the planar shape of the second portion 34B, 134B, 234B may be circular, whereas the planar shape of each of the first groove portions 34D, 134D, 234D may substantially be a circular arc shape, and the plurality of the first groove portions 34D, 134D, 234D may be disposed side by side at intervals on the same circumference. The second groove portion 34E may also have a configuration similar to the configuration described above.

(5) A plurality of the first groove portions 34D, 134D, 234D may be provided so that distances from the second portion 34B, 134B, 234B are different from each other. For example, the planar shape of the second portion 34B, 134B, 234B may be circular, the planar shape of each of the first groove portions 34D, 134D, 234D may be substantially circular, and the plurality of the first groove portions 34D, 134D, 234D may have different radial dimensions and may be concentrically arranged at intervals in the radial direction of the second portion 34B, 134B, 234B. The second groove portion 34E may also have a configuration similar to the configuration described above.

(6) The first groove portion 34D, 134D, 234D may be arranged without a gap from the second portion 34B, 134B, 234B. That is, an inner peripheral end of the first groove portion 34D, 134D, 234D may be arranged to coincide with an outer peripheral end of the second portion 34B, 134B, 234B. The second groove portion 34E may also have a configuration similar to the configuration described above.

(7) The second groove portion 34E may be omitted.

(8) In the fifth step included in the array substrate manufacturing process, a negative photosensitive resin film may be used as the flattening film 34, 134.

(9) In the fifth step included in the array substrate manufacturing process, a gray tone mask may be used as the photomask.

(10) In the film composition of the array substrate 21, 121, the first interlayer insulating film 33, 133 may be omitted.

(11) There may be a relationship such that the second portion 34B, 134B, 234B partially overlaps the first spacer 38α, 138α. Similarly, there may be a relationship such that the third portion 34C and the second spacer 38β partially overlap each other.

(12) The specific planar arrangement of the second portion 34B, 134B, 234B, the third portion 34C, and the spacer 38α, 38β, 138α in the display region AA of the array substrate 21, 121 may be appropriately changed to an arrangement different from the one illustrated in the drawings. Even in this case, it is preferable that there is a relationship such that the second portion 34B, 134B, 234B, the third portion 34C, and the spacer 38α, 38β, 138α overlap at least the light blocking portion 29 of the counter substrate 20 in order to maintain a high aperture ratio of the pixel PX.

(13) The specific planar arrangement of the TFT 24 in the display region AA of the array substrate 21, 121 can be appropriately changed to an arrangement different from the one illustrated in the drawings. For example, all of the TFTs 24 may be connected to the pixel electrodes 25 on one side (the left side in FIG. 3) in the X-axis direction with respect to the source wiring line 27 to be connected. Alternatively, all the TFTs 24 may be connected to the pixel electrodes 25 on the other side (the right side in FIG. 3) in the X-axis direction with respect to the source wiring line 27 to be connected.

(14) The formation range and the arrangement of the third portion 34C and the second spacer 38β in a plan view may be appropriately changed to a formation range and an arrangement different from the ones illustrated in the drawings. For example, the third portion 34C and the second spacer 38β may be arranged at points in the vicinity of the intersection location of the gate wiring line 26 and the source wiring line 27, similarly to the second portion 34B, 134B, 234B and the first spacer 38α, 138α.

(15) The first spacer 38α, 138α may have the same height as the second spacer 38β. In this case, the height of the second portion 34B, 134B, 234B may be set to a higher value than the height of the third portion 34C.

(16) The third portion 34C may be lower than the second portion 34B, 134B, 234B. In this case, the third upper surface 34C1 is arranged lower than the second upper surface 34B1, 134B1.

(17) The source wiring line 27 may extend substantially straight in the Y-axis direction. In this case, the main body portion 25A of the pixel electrode 25 also has a substantially straight planar shape along the Y-axis direction. The color filter 28 is also configured to extend substantially straight along the Y-axis direction.

(18) Instead of the gate drive circuit 15, a gate driver may be mounted on the array substrates 21, 121.

(19) The material of the semiconductor film provided in the array substrate 21, 121 may be a polycrystalline polysilicon material and the like.

(20) The number and arrangement of the drivers 12 being provided may be appropriately changed to a number and an arrangement different from the ones illustrated in the drawings.

(21) In the display region AA, the light blocking portion 29 may have a stripe shape extending along the Y-axis direction.

(22) The pixel electrode 25 may be located on the lower layer side with respect to the second interlayer insulating film 35, and the common electrode 37 may be located on the upper layer side with respect to the second interlayer insulating film 35. In this case, it is preferable to form a slit for alignment control in the common electrode 37.

(23) The planar shape of the liquid crystal panel 11 may be a vertically elongated rectangular shape, a square, a circular shape, a semi-circular shape, an oval shape, an elliptical shape, a trapezoidal shape, and the like.

(24) The liquid crystal panel 11 may not be a transmissive liquid crystal panel, and may be a transflective liquid crystal panel or a reflective liquid crystal panel.

(25) The display mode of the liquid crystal panel 11 may not be the FFS mode, and may be a Multi-domain Vertical Alignment (MVA) mode, an In-Plane Switching (IPS) mode, a Twisted Nematic (TN) mode, and the like.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A display device comprising:
a first substrate;
a second substrate facing the first substrate with a gap between the first substrate and the second substrate;
a first spacer provided in the first substrate and protruding from the first substrate toward the second substrate;
an alignment film provided in the second substrate and located in an uppermost layer; and
a first insulating film provided in the second substrate and disposed on a lower layer side from the alignment film,
wherein the first insulating film includes a first portion having a first upper surface as an upper surface and a second portion having a second upper surface higher than the first upper surface as an upper surface,
the second portion overlaps the first spacer, and
the first portion includes a groove portion surrounding the second portion.

2. The display device according to claim 1,
wherein the groove portion has an annular shape surrounding the entire periphery of the second portion.

3. The display device according to claim 1,
wherein the groove portion extends along a planar shape of the second portion.

4. The display device according to claim 1,
wherein the groove portion has a recessed shape including a bottom surface.

5. The display device according to claim 1,
wherein the groove portion extends through the first portion.

6. The display device according to claim 5, comprising:
a thin film transistor provided in the second substrate; and
a pixel electrode provided in the second substrate and connected to the thin film transistor,
wherein the thin film transistor includes a first electrode disposed on a lower layer side of the first insulating film and overlapping a part of the pixel electrode and a part of the first portion, and
a contact hole connecting the first electrode and the pixel electrode extends through the first portion at a position overlapping both the first electrode and the pixel electrode.

7. The display device according to claim 1, comprising:
a second spacer provided in the first substrate and protruding from the first substrate toward the second substrate,
wherein the second spacer has a smaller protruding dimension from the first substrate than a protruding dimension of the first spacer,
the first insulating film includes a third portion having, as an upper surface, a third upper surface that is higher than the first upper surface and that has the same height as the second upper surface or is lower than the second upper surface,
the third portion overlaps the second spacer, and
a portion overlapping the first spacer in a surface of the first substrate facing the second substrate, contacts a portion overlapping the second portion in a surface of the second substrate facing the first substrate.
